(19) United States
(12) Patent Application Publication
(10) Pub. No.: US 2024/0297612 A1
(43) Pub. Date: Sep. 5, 2024

(54) Ground-Based Photovoltaic System

(71) Applicants: Stefan Christ, Essen (DE); Claus Linnemann, Essen (DE)

(72) Inventors: Stefan Christ, Essen (DE); Claus Linnemann, Essen (DE)

(73) Assignee: RWE Renewables Europe & Australia GmbH, Essen (DE)

(21) Appl. No.: 18/647,541

(22) Filed: Apr. 26, 2024

Related U.S. Application Data
(63) Continuation of application No. PCT/EP2022/082892, filed on Nov. 23, 2022.

(30) Foreign Application Priority Data
Dec. 21, 2021 (DE) 10 2021 134 122.1

(51) Int. Cl. H02S 20/32; H02S 50/00

(52) U.S. Cl. CPC H02S 20/32; H02S 50/00

(57) ABSTRACT

A photovoltaic system is installable on a substantially planar installation surface. The photovoltaic system includes at least one main photovoltaic system having at least one photovoltaic reference system corresponding to the main photovoltaic system. A control device is configured to adjust the tracker angle of main solar tracker devices based on the determined shading state of a first module element and/or a second module element.

### CROSS-REFERENCE TO RELATED PATENT APPLICATIONS

This patent application is a continuation of International Application No. PCT/EP2022/082892, filed on Nov. 23, 2022, which claims the benefit of priority to German Patent Application No. 10 2021 134 122.1, filed Dec. 21, 2021, the entire teachings and disclosures of both applications are incorporated herein by reference thereto FIELD OF THE DISCLOSURE

The application relates to tracked photovoltaic systems which are installable (and ground-based, respectively) on a flat installation surface and, in particular, are tracked, and methods for operating such photovoltaic systems.

### BACKGROUND OF THE INVENTION

Nowadays, so-called renewable energies are increasingly being used in order to generate electrical energy. For example, it is known to convert the energy of solar irradiance and solar energy, respectively, into electrical energy using photovoltaic modules. A photovoltaic module, also known as a solar module, comprises a plurality of solar cells that can be connected in series and/or parallel and can convert solar energy into electrical energy.

In addition to the arrangement of photovoltaic modules on pitched roofs, it is also known to install solar farms and photovoltaic farms, respectively, on horizontal respectively flat installation surfaces. A photovoltaic farm that can be installed on such an installation surface (in particular, a ground-based photovoltaic farm) comprises a plurality of photovoltaic modules arranged on at least one support. In order to increase the energy yield, ground-based photovoltaic farms respectively photovoltaic systems are often designed as tracking support systems. In principle, single-axis support systems and dual-axis support systems are known.

From the prior art, photovoltaic systems are known having a plurality of horizontal single-axis solar tracker devices, which are arranged in parallel rows, each device comprising at least one photovoltaic module, usually a plurality of photovoltaic modules. A horizontal single-axis solar tracker respectively a horizontal single-axis solar tracker device is also known as a “single axis horizontal tracker” (SAHT). Such solar tracker devices offer the possibility of adjusting a tracker angle in order to change the orientation of the photovoltaic modules, also known as photovoltaic panels, of the solar tracker device.

In particular, a control device for adjusting the tracker angle of a solar tracker device can be provided in the photovoltaic system. By adjusting a tracker angle, the photovoltaic modules of the solar tracker device can be aligned at a more optimal angle to the sun. This can increase the energy yield. In the prior art, the tracker angle to be adjusted is generally determined by an algorithm that determines the position of the sun in relation to the surface of the photovoltaic modules. The tracker angle is then adjusted and set, respectively, depending on this.

However, the optimum alignment to the sun in the morning hours and evening hours leads, in particular, to the rows at the back seen from the sun's position being shaded. In particular, a front photovoltaic module may cast a shadow on the photovoltaic module behind it, meaning that a partial shading of photovoltaic modules may occur. This in turn leads to a significant reduction in energy yield.

In order to prevent this, it is known from the prior art that the solar tracker devices are adjusted according to a so-called “back-tracking” mode at the times mentioned. This mode is intended to prevent photovoltaic modules from being shaded by other upstream photovoltaic modules.

In practice, however, various problems occur with such a photovoltaic system. For example, these algorithms are regularly unable to completely prevent shading respectively shadows being cast in backtracking mode. The reason for this is that the known algorithms comprise a complex function that depends on the position of the sun and the actual arrangement of the photovoltaic system and the orientation of the solar tracking devices. These algorithms are generally not perfect so that the angle to the sun (and therefore the tracker angle to be adjusted) is not calculated completely correctly. In practice, this leads to partial and temporary shading and therefore a reduction in energy yield.

In addition, on days with little direct sunlight (e.g., in case of very hazy and/or cloudy weather conditions), the alignment and orientation, respectively, of the photovoltaic modules to the sun is not the position in which electricity production is maximized. The reason for this is that in case of such meteorological conditions, irradiation that does not come from the direction of the sun dominates the generated electrical power.

In order to further improve the energy yield, in the prior art it is constantly tried to optimize the algorithm. In practice, however, this has not led to the problems described above being completely solved.

### SUMMARY OF THE INVENTION

Therefore, the object of the present application is to provide a photovoltaic system which is installable on an essentially flat installation surface and, which is tracked, in which the described problems of the prior art are at least reduced and, in particular, the energy yield of the photovoltaic system is increased.

According to a first aspect of the application, the problem is solved by a photovoltaic system according to claim 1 which can be installed on a substantially flat installation surface (in particular, a ground-based photovoltaic system). The photovoltaic system according to the application comprises at least one main photovoltaic system with a plurality of horizontal single-axis main solar tracker devices arranged in parallel rows to each other, each having at least one main photovoltaic module, wherein two horizontal single-axis main solar tracker devices arranged in adjacent rows (each) have a first distance to each other, and having at least one control device configured to adjust a tracker angle of the main solar tracker devices. The photovoltaic system further comprises at least one photovoltaic reference system corresponding to the main photovoltaic system and having a first row with at least one horizontal single-axis reference solar tracker device having at least one first module element, at least one second row with at least one horizontal single-axis reference solar tracker device having at least one second module element, wherein at least the geometry of the first module element and the geometry of the second module element are identical to the geometry of the main photovoltaic module, wherein the first row and the second row are arranged parallel to one another and having a specific second distance from one another which is identical to the first distance, having at least one shading evaluation equipment coupled to at least one optical detection equipment, wherein the shading evaluation equipment is configured to determine a shading state of the first module element and/or of the second module element, wherein the tracker angles of the reference solar tracker devices and the tracker angle of the main solar tracker devices are at least temporarily identical during the determining of the shading state of the first module element and/or of the second module element. The control device is configured to adjust the tracker angle of the main solar tracker devices based on the determined shading state of the first module element and/or the second module element.

In contrast to the prior art, in accordance with the application by providing a photovoltaic reference system corresponding to the main photovoltaic system, also referred to as a photovoltaic test system, and in this photovoltaic reference system a shading state of a first module element and/or the second module element is determined by an optical detection equipment of the photovoltaic system, wherein the tracker angle of the main photovoltaic system is adjusted depending on the determined shading state, the described problems of the prior art are at least reduced and the energy yield of the photovoltaic system is increased. Thus, even a slight shading of the photovoltaic modules is detected immediately and can be eliminated immediately by adjusting respectively moving the main solar tracker devices. However, by using a photovoltaic reference system to determine the shading state, unnecessary interventions in respectively changes to the main photovoltaic system are avoided.

The photovoltaic system is arranged on an essentially horizontally running, i.e., flat ground respectively an essentially horizontally running, i.e., flat installation surface. This means, in particular, that the main solar tracker devices and the reference solar tracker device are arranged on an essentially flat respectively horizontal (equal) installation surface (slope of the surface at least less than 10%, preferably less than 5%, particularly preferably less than 2%). Arrangement on flat roofs or the like is not excluded in the application.

The photovoltaic system according to the application comprises a main photovoltaic system and a photovoltaic reference system. The photovoltaic reference system is, in particular, a significantly smaller system than the main photovoltaic system. In particular, the number of module elements in the photovoltaic reference system can be a maximum of 10% of the number of photovoltaic modules in the main photovoltaic system, preferably a maximum of 5%, particularly preferably a maximum of 2%.

The main photovoltaic system comprises a plurality of rows, preferably each comprising a plurality of photovoltaic modules. As has been described, each photovoltaic module can comprise a plurality of solar cells. The (module) rows run parallel to each other. In addition, all neighboring rows can have the same first distance to each other.

At least one horizontal single-axis main solar tracker device is arranged in each row. A horizontal single-axis (main and reference, respectively) solar tracker device according to the application comprises at least one support and at least one photovoltaic module arranged on the support. In the case of a main solar tracker device, a plurality of main photovoltaic modules, in particular, arranged directly adjacent to one another, can preferably be provided.

A support can be formed by at least one support base and at least one elongated support element attached to the support base. For example, a support base can be arranged at each of the outer ends of the elongated support element (e.g., a rod, for example made of metal). In an installation state of a solar tracker device, the elongate support element is arranged in an essentially horizontal plane (in particular, parallel to planes on which the at least one support base is positioned).

In the present single-axis horizontal solar tracker devices, the elongate support element can preferably be formed by a cylindrical support element, for example, a horizontal tube. Such an elongate support element may comprise pylons or frames as support base/bases, on which the elongate support element may be mounted.

The axis of the elongated support element can, for example, lie on a north-south line. The at least one photovoltaic module can be mounted on the elongated support element. The elongated support element can be rotatable about its axis in order to adjust a tracker angle of the solar tracker device. In particular, this allows the apparent movement of the sun to be tracked during the course of the day.

In order to rotate the elongated support element respectively adjust the tracker angle, each solar tracker device can preferably comprise a controllable drive, for example, in the form of an electric motor. In particular, the drive can be controlled by the control device in order to adjust the tracker angle of a solar tracker device.

A tracker angle can also be referred to as the angle of inclination of the module element and/or photovoltaic module.

As has already been described, single-axis solar tracker devices and corresponding tracking systems, respectively, have (exactly) one degree of freedom, which serves as the axis of rotation. The axis of rotation for horizontal single-axis solar tracker devices is horizontal to the (flat) installation surface. In particular, the axis of rotation is the axis of the elongated support element.

The support bases can, for example, be arranged at both ends of the axis of rotation of a horizontal single-axis solar tracker device so that two axes of rotation can share one support base. In the case of horizontal single-axis solar tracker devices, the surface of the photovoltaic module is, in particular, aligned parallel to the axis of rotation.

Furthermore, a parallel arrangement of two main solar tracker devices to each other means, in particular, that the respective elongated support elements run essentially parallel to each other.

As has already been described, a photovoltaic reference system corresponding to the photovoltaic system is provided in accordance with the application. Corresponding here means, in particular, that a reference solar tracker device can essentially correspond geometrically to at least one section of a main solar tracker device. For example, the reference solar tracker device can be essentially identical to a main solar tracker device, but shorter in the direction of the axis of the elongated support element than the main solar tracker device. In other words, the support of a reference solar tracker device can be shorter, but otherwise identical to the support of a main solar tracker device. The number of module elements on the elongated support element of the reference solar tracker device can, in particular, be smaller than the number of photovoltaic modules on the elongated support element of the main solar tracker device. For example, a reference solar tracker device may have between one and five module elements, preferably two or three.

The photovoltaic reference system comprises at least two parallel rows, each having a horizontal single-axis reference solar tracker device. Each reference solar tracker device comprises at least one module element as described.

According to the application, at least the geometry (in particular, the contour) of the first module element and the geometry of the second module element are identical to the geometry of the main photovoltaic module. In particular, it has been recognized that in the event that (only) a (potential) shading of main photovoltaic modules is to be detected, it is sufficient if the geometry of the first module element and the geometry of the second module element are identical to the geometry of the main photovoltaic module. According to the application, an identical geometry is present if the outline and contour, respectively, of a module element is essentially identical to the outline and contour, respectively, of the main photovoltaic module.

According to one embodiment, the first module element can be a pseudo-photovoltaic module, i.e., in particular it does not comprise any solar cells. For example, a pseudo-photovoltaic module can be a plate-shaped element made of plastic, metal, wood or the like, and can, in particular, have the geometry of the main photovoltaic module. Alternatively, the first module element can be a reference photovoltaic module identical to the main photovoltaic module.

Alternatively or additionally, the second module element can be a pseudo-photovoltaic module, i.e., in particular it does not comprise any solar cells. For example, a pseudo-photovoltaic module can be a plate-shaped element made of plastic, metal, wood or the like, and can, in particular, have the geometry of the main photovoltaic module. Alternatively, the second module element can be a reference photovoltaic module identical to the main photovoltaic module.

As has been already described, the first (module) row and the second (module) row of the photovoltaic reference system are arranged parallel to each other. Furthermore, they have a certain second distance to each other, which is identical to the first distance.

In a simple way, the shading behavior in the main photovoltaic system can be mapped in the photovoltaic reference system.

Furthermore, an optical detection equipment is provided in accordance with the application. The photovoltaic reference system can preferably comprise the at least one optical detection equipment. The optical data recorded by the optical detection equipment, for example, at least one optical sensor, can be provided to a shading evaluation equipment. The shading evaluation equipment can, for example, be integrated in the control device.

The shading evaluation equipment is configured to determine a shading state of the first module element and/or the second module element, in particular, based on the optical data received. In particular, this means a determining whether the first module element casts (or does not cast) a shadow at least partially on the second module element or is expected to cast (or not to cast) a shadow soon (<15 min, preferably <5 min), or whether the second module element casts (or does not cast) a shadow at least partially on the first module element or is expected to cast (or to not cast) a shadow soon (<15 min, preferably <5 min).

In particular, at least two different shading states can be determined, for example, “shading has occurred” in the event of a detection (based on the evaluation of the optical data) of an at least potential partial shadow on one of the module elements and “no shading” in the event of a detection that there is no shadow on one of the module elements (based on the evaluation of the optical data).

The tracker angles of the respective reference solar tracker devices and the tracker angle of the main solar tracker devices (as a rule, all main solar tracker devices (always) have the same tracker angle) are at least temporarily identical during the determining of the shading state of the first module element and/or the second module element. In other words, the first module element and the second module element are oriented (at least temporarily) identically to the main photovoltaic modules.

In one embodiment, at least when determining a shading state, according to which it is likely that a part of a module element will soon be shaded, i.e., “shading is occurring”, prior to an (actual) adjustment of the tracker angles in the main photovoltaic system an adjustment of the tracker angles in the photovoltaic reference system can first be carried out. The effect of the adjustment can then, in particular, be evaluated. In particular, a shading state of the first module element and/or the second module element can be determined again (now with a changed tracker angle). Based on the first determined shading state and the optionally determined further shading state, the tracker angle of the main solar tracker devices can be adjusted, i.e., in particular, adapted.

If, for example, the optionally determined further shading state has shown that there is no actual shading with a correspondingly adjusted tracker angle and, for example, no “shading is occurring”, this adjusted tracker angle of the photovoltaic reference system can be used as the set tracker angle for the main photovoltaic system. For example, this set tracker angle can be provided to the control device. Otherwise, adjustment can be omitted and/or a further evaluation can take place.

The control device is configured to adjust the tracker angle of the main solar tracker devices based on the determined shading state of the first module element and/or the second module element. In particular, the at least one drive described above can be controlled to cause an adjusting of the tracker angle of the main solar tracker devices.

For example, the control device can control the drive based on a set tracker angle respectively with this angle. Alternatively or additionally, an adjusted set tracker angle can be determined from stored angle adjustment rules and the provided (first) shading state (and/or a further shading state). For example, an angle adjustment rule can determine whether and by which angle value a tracker angle is to be adjusted if a certain shading state is present. Based on the adjusted set tracker angle, the at least one drive of the main solar tracker devices can be controlled.

The tracker angles of the reference solar tracker devices can be adjusted accordingly once the tracker angle of the main solar tracker devices has been adjusted.

The shading behavior of a main photovoltaic system can be monitored in a simple manner.

According to a further embodiment of the photovoltaic system installable on a substantially flat installation surface, the photovoltaic reference system can be an (internal) subsystem of the main photovoltaic system. In other words, the main photovoltaic system comprises the photovoltaic reference system. The photovoltaic reference system is therefore a part of the main photovoltaic system. In this embodiment, the first and second module elements are main photovoltaic modules, which take the function of reference photovoltaic modules.

The control device can be configured to adjust a tracker angle of the reference solar tracker devices, in particular, independently of the set tracker angle of the other main solar tracker devices of the main photovoltaic system.

As the photovoltaic reference system is part of the main photovoltaic system, the shading behavior of the photovoltaic system can be mapped particularly accurately.

According to a further embodiment of the photovoltaic system according to the application, the photovoltaic reference system can be a separate (and external, respectively) photovoltaic system. The photovoltaic reference system can be arranged adjacent (e.g., the distance can be less than 20 m) to the main photovoltaic system. As a result, the meteorological conditions and the installation area of the photovoltaic reference system and the main photovoltaic system are (at least almost) identical.

The control device can be configured to adjust a tracker angle of the solar tracker devices of the (external) photovoltaic reference system, in particular, independently of the set tracker angle of the other main solar tracker devices of the main photovoltaic system.

With a separate photovoltaic reference system respectively an external photovoltaic reference system, the use of functional photovoltaic modules can be advantageously dispensed with, as already described. Costs can be saved.

In variants of the application, at least two photovoltaic reference systems can also be provided, wherein at least one internal subsystem and/or at least one separate (external) photovoltaic reference system can be provided.

As has been already described, according to one embodiment of the photovoltaic system, the photovoltaic system may comprise the at least one optical detection equipment. The optical detection equipment may be at least one camera (preferably, a plurality of cameras may be provided), which may be configured to detect a light area occurring on the installation surface between the first row and the second row of the photovoltaic reference system. In particular, it has been recognized that the shading state can be inferred from the presence or absence of light hitting on the ground which can, in particular, form a light area. As long as a light area can be detected on the installation surface, it can be concluded that there is no shading, i.e., the shading state is “no shading”.

If there is no (or an insufficient) light area, i.e., if no light rays (or too few) hit the ground, it can be concluded that there is shading, i.e., that the shading state is “shading has occurred”. In this case, it is also preferable to first check whether the main photovoltaic modules and/or the reference photovoltaic modules are generating electrical energy (above a certain limit energy). Only if sufficient electrical energy is generated the shading state (e.g., a shading state is occurring or a occurred shading state) can be inferred.

Preferably, the shading evaluation equipment can be configured to determine the width of the detected light area. The shading evaluation equipment can be configured to compare the width of the detected light area with a light area width criterion (e.g., a permissible minimum light area width). The shading evaluation equipment can be configured to determine the shading state of the first module element and/or the second module element based on the comparison result.

If the light area width criterion is fulfilled by the width of the detected light area (e.g., the detected width of the light area is greater than the permissible minimum light area width), the shading state “no shading” can be concluded, for example. If the light area width criterion is not fulfilled by the width of the detected light area (e.g., the detected width of the light area is smaller than the permissible minimum light area width), the shading state “shading has occurred” and/or “shading is occurring” can be concluded, for example.

In particular, an image evaluation tool can be used to determine the brightness in the detected image data.

The shading state can be determined in a reliable and simple manner.

According to a preferred embodiment of the photovoltaic system according to the application, the photovoltaic system can comprise, as described, the at least one optical detection equipment. The optical detection equipment can comprise at least one first light sensor arranged at an edge of the first module element and at least one second light sensor arranged at an edge of the second module element. For example, a light sensor can comprise at least one photodiode, preferably, a plurality of photodiodes, respectively be formed by the at least one photodiode. Depending on the incident light intensity, the first light sensor and/or the second light sensor can generate optical data (containing a light intensity parameter value), e.g., in the form of a sensor signal, and in particular can provide it to the shading evaluation equipment. Based on the optical data, it is easy to determine whether a shading has occurred.

For example, a light intensity criterion (e.g., a minimum light intensity) can be specified. If, for example, the detected light intensity parameter value exceeds the minimum light intensity, the shading state “no shading” can be concluded. If, for example, the detected light intensity parameter value does not exceed the minimum light intensity, the shading state “shading occurred” can be inferred. If, for example, the detected light intensity parameter value does not exceed the minimum light intensity, the shading state “shading occurred” or “shading is occurring” can be inferred.

The edge of the first module element and the edge of the second module element can, in an installation state and, in particular, in the respective horizontal position of the module elements, face each other respectively be (directly) opposite to each other. A light sensor can extend at least partially along the edge (in the axial direction of the elongate support element), preferably almost completely.

As has been described, the shading evaluation equipment can preferably be configured to determine the shading state of the first module element and/or the second module element based on a light state of the first light sensor and/or a light state of the second light sensor, i.e., in particular on the sensor signals received. By arranging light sensors at at least one specific edge, the shading state of a module element can be determined in a simpler manner.

It is particularly preferable for a (first and/or second) light sensor to have at least two adjacent rows of light sensors, in particular, running parallel to the installation surface. Depending on whether light (with at least one certain (predetermined) minimum light intensity) falls on both rows of light sensors, only on one row of light sensors or on no row of light sensors, the shading state can be determined in a simple manner.

In particular, the shading evaluation equipment can be configured to determine, as the shading state, “no shading” (for the case that solar irradiation (with at least one certain minimum intensity) falls on both light sensor rows), “shading is occurring” (for the case that only one light sensor row (in particular, the bottom row seen in the vertical direction) is exposed to solar irradiation (with at least one certain minimum intensity)) and a “shading occurred” (for the case that none of the light sensor rows is exposed to solar radiation (with at least one certain minimum intensity)), based on the light state of the first light sensor row and the light state of the second light sensor row.

As has been described, the rows of light sensors (each with at least one photodiode or the like) can be placed at a certain distance so that the following can be concluded directly from the sensor signals: “shading is occurring” and “shading is occurred”. This enables the control device in particular to keep the main photovoltaic modules (with a corresponding backtracking algorithm) preferably in the “shading is occurring” position (permanently). Depending on the installation location, the light sensors can be placed at the points that are most susceptible to shading respectively shadowing (if the surface is not completely flat or the rows are not completely parallel).

Furthermore, in particular as an alternative to the previous pieces of optical detection equipment, but also in addition thereto, according to a further embodiment of the photovoltaic system, the photovoltaic system may comprise the at least one optical detection equipment, wherein the optical detection equipment may be at least one elongate light sensor arranged on the installation surface between the first row and the second row of the photovoltaic reference system. For example, the elongated light sensor may comprise photodiodes and/or at least one solar cell. In particular, the elongated light sensor can be a (thin) strip sensor with an elongated solar cell arranged below the rows of the photovoltaic reference system parallel to the ground respectively the installation surface. An example of such a sensor is a Heliatek foil. In the event of a short circuit, the current emitted by this solar cell will drop significantly when the shading situation is reached, as the cell is no longer exposed to direct sunlight. This can be evaluated by the shading evaluation equipment and, in particular, used by the control device to adjust the tracker angle of the main tracker devices.

In particular, according to a further embodiment, it can be provided that the shading evaluation equipment is configured to determine the shading state of the first module element and/or the second module element based on a light state of the elongated light sensor arranged on the installation surface. The use of a corresponding elongated light sensor as an optical detection equipment is particularly advantageous if the installation of light sensors is not possible or at least hardly possible.

According to a particularly preferred embodiment of the photovoltaic system, the first module element can be a first reference photovoltaic module and the second module element can be a second reference photovoltaic module. The first reference photovoltaic module and the second reference photovoltaic module may be identical to the main photovoltaic module. The photovoltaic reference system may comprise at least one power evaluation equipment configured to compare a first electrical power parameter value generated by the first reference photovoltaic module and a second electrical power parameter value generated by the second reference photovoltaic module. The tracker angle of the horizontal single-axis reference solar tracker device of the first reference photovoltaic module may be identical to the set tracker angle of the main solar tracker devices. The tracker angle of the horizontal single-axis reference solar tracker device of the second reference photovoltaic module may be different from the set tracker angle of the main solar tracker devices. The control device may be configured to adjust the tracker angle of the main solar tracker devices based on the comparison result. This independently inventive aspect is described in more detail below.

A further aspect of the application is a method of operating a photovoltaic system described above. The method comprises:
determining a shading state of the first module element and/or the second module element, and
adjusting the tracker angles of the main solar tracker devices based on the determined shading state of the first module element and/or the second module element.

A further aspect of the application is a photovoltaic system installable on a substantially flat installation surface (in particular, ground-based). The photovoltaic system comprises at least one main photovoltaic system with a plurality of horizontal single-axis main solar tracker devices arranged in parallel rows to each other, each device having at least one main photovoltaic module, wherein two horizontal single-axis main solar tracker devices arranged in adjacent rows have a first distance to each other, and having at least one control device configured to adjust the tracker angle of the main solar tracker devices. The photovoltaic system further comprises at least one photovoltaic reference system corresponding to the main photovoltaic system having a first row of at least one horizontal single-axis reference solar tracker device having at least one first reference photovoltaic module, at least one second row of at least one horizontal single-axis reference solar tracker device having at least one second reference photovoltaic module, wherein the first reference photovoltaic module and the second reference photovoltaic module are identical to the main photovoltaic module, and comprising at least one power evaluation equipment configured to compare a first electrical power parameter value generated by the first reference photovoltaic module and a second electrical power parameter value generated by the second reference photovoltaic module. The tracker angle of the horizontal single-axis reference solar tracker device of the first reference photovoltaic module is identical to the set tracker angle of the main solar tracker devices. The tracker angle of the horizontal single-axis reference solar tracker device of the second reference photovoltaic module differs from the set tracker angle of the main solar tracker devices. The control device is configured to adjust the tracker angle of the main solar tracker devices based on the comparison result.

In contrast to the prior art, in accordance with the application, by providing a photovoltaic reference system corresponding to the main photovoltaic system, also referred to as a photovoltaic test system, wherein a power parameter value of at least one reference photovoltaic module is detected in the photovoltaic reference system, wherein the tracker angle of the reference photovoltaic module respectively the corresponding reference solar tracker device differs from the set tracker angle of the main solar tracker devices and the at least one further reference solar tracker device, it is possible to evaluate whether an increase in yield is possible with a changed tracker angle without changing the orientation of the main photovoltaic modules in the main photovoltaic system for this purpose.

The main photovoltaic system is formed in accordance with the above explanations, so that reference is made to these explanations at this point. Reference is also made to the previous explanations with regard to the photovoltaic reference system and the correspondence of the photovoltaic reference system to the main photovoltaic system in order to avoid repetitions.

In the present case, the photovoltaic reference system has at least one first (functional) reference photovoltaic module and at least one second (functional) reference photovoltaic module, which are identical to the installed main photovoltaic modules. The number (e.g., one or two) of first reference photovoltaic modules is in particular identical to the number (e.g., one or two) of second reference photovoltaic modules.

At least each row of the photovoltaic reference system may comprise at least one inverter electrically connected to the respective at least one reference photovoltaic module. The respective inverter provides the electrical power parameter value, for example, a current and/or a voltage. These values can be used, for example, to determine the power generated in each case.

Preferably, the first power parameter value and second power parameter value can be detected for respectively during a specific time period. For example, the first total power of the first reference photovoltaic module generated during the specified time period (e.g., between 1 min and 15 min) and the second total power of the second reference photovoltaic module generated during this time period can be detected and determined, respectively.

The power evaluation equipment is configured to compare the first electrical power parameter value generated by the first reference photovoltaic module and the second electrical power parameter value generated by the second reference photovoltaic module. In particular, it can be determined which of the at least two compared power parameter values is greater. In other words, it can be determined which reference photovoltaic module delivers more power (in particular, during the specified time period).

From this, it can be deduced at which tracker angle the energy yield is currently greater. Based on the comparison result, the control device can adjust the tracker angle of the main solar tracker devices. In particular, this means that the tracker angle of the main solar tracker devices is not adjusted if the first power parameter value is greater than or equal to the second power parameter value. In particular, the control device is configured to adjust the tracker angle of the main solar tracker devices if the second power parameter value is greater than the first power parameter value. It shall be understood that in variants of the application, there must be a minimum difference between the power parameter values so that an adjustment is actually carried out.

Preferably, the present photovoltaic system may comprise at least one optical detection equipment as described above. In particular, the present photovoltaic system may comprise a shading evaluation equipment as described above. In other words, the two described photovoltaic systems (and preferred embodiments thereof) may be combined with each other.

According to a particularly preferred embodiment of the photovoltaic system, the control device may be configured to adjust the tracker angle of the horizontal single-axis reference solar tracker device of the second reference photovoltaic module starting from the tracker angle of the horizontal single-axis reference solar tracker device of the first reference photovoltaic module (respectively the main tracker devices) by a first (preferably positive) angular value for respectively during a first period of time. The control device may be configured to adjust the tracker angle of the horizontal single-axis reference solar tracker device of the second reference photovoltaic module by a second (preferably negative) angular value for respectively during a second time period (after the first time period), starting from the tracker angle of the horizontal single-axis reference solar tracker device of the first reference photovoltaic module. The first angular value and second angular value may differ. The power evaluation equipment may be configured to compare a second power parameter value generated during the first time duration, a further power parameter value generated during the second time duration and the first power parameter value generated (during the first and/or second time duration). The control device may be configured to adjust the tracker angle of the main solar tracker devices based on the comparison result.

Preferably, the tracker angle can be adjusted which, based on the comparison carried out, proves to be the most optimal, i.e., in particular, at which the generated power is maximum.

In particular, this process can be carried out regularly and/or at certain times and/or under certain predetermined meteorological conditions in order to determine the optimal orientation of the main solar tracker devices.

According to a further embodiment of the photovoltaic system, the control device can be configured to adjust the horizontal single-axis reference solar tracker device of the first reference photovoltaic module and the second reference photovoltaic module each to a horizontal position during a calibration period. The power evaluation equipment may comprise a calibration module configured to calibrate the power evaluation equipment based on the first electrical power parameter value generated during the calibration time period and the second electrical power parameter value generated during the calibration time period. By performing a calibration preferably once a day, for example, in the morning, it can be ensured that any existing power differences between the reference solar tracker devices together with the reference photovoltaic modules, for example, due to manufacturing tolerances or due to losses during the operating time, do not lead to incorrect comparison results and, in particular, incorrect settings of the tracker angle of the main photovoltaic modules.

A still further aspect of the application is a photovoltaic system which can be installed on a substantially flat installation surface (i.e., in particular, ground-based), comprising at least one main photovoltaic system with a plurality of horizontal single-axis main solar tracker devices arranged in parallel rows to one another, each having at least one main photovoltaic module, wherein two horizontal single-axis solar tracker devices arranged in adjacent rows have a first distance from one another, and having at least one control device configured to adjust the tracker angle of the main solar tracker devices. The photovoltaic system further comprises at least one photovoltaic reference system having at least four fixed horizontal single-axis reference solar tracker devices each having a reference photovoltaic module, the four fixed horizontal single-axis reference solar tracker devices having different tracker angles, having at least one power evaluation equipment configured to compare the electrical power parameter values generated by the four fixed horizontal single-axis reference solar tracker devices. The control device is configured to adjust the tracker angle of the main solar tracker devices based on the comparison result.

The main photovoltaic system is formed according to the above explanations so that reference is made to these explanations at this point. Reference is also made to the previous explanations with regard to the photovoltaic reference system and the correspondence of the photovoltaic reference system to the main photovoltaic system in order to avoid repetitions.

In accordance with this photovoltaic system, the photovoltaic reference system is represented by at least four, preferably at least seven, particularly preferably at least 10 reference solar tracker devices, each having (exactly) one reference photovoltaic module. The respective reference photovoltaic modules are, in particular, identical to each other.

The reference solar tracker devices are fixed. This means, in particular, that the respective tracker angle of the reference solar tracker devices is unchangeable. In other words, the orientation of the reference photovoltaic module of such a reference solar tracker device is not variable.

Furthermore, according to the application, the at least four reference solar tracker devices have different tracker angles. In one embodiment, the respective angular difference between two reference solar tracker devices with adjacent tracker angles, i.e., in particular without a reference solar tracker device having a tracker angle lying between the adjacent tracker angles, may be the same.

Preferably, each fixed reference solar tracker device may comprise an inverter electrically connected to the respective reference photovoltaic module. The respective inverter provides the electrical power parameter value, for example, a current and/or a voltage. These values can be used, for example, to calculate the power generated in each case.

Preferably, the at least four power parameter values of the respective fixed reference solar tracker devices can be detected for respectively during a specific period(s) of time. For example, at least the first total power of the first reference photovoltaic module generated during the specific period of time (e.g., between 1 min and 15 min), the second total power of the second reference photovoltaic module generated during this period of time, the third total power of the third reference photovoltaic module generated during this period of time and the fourth total power of the fourth reference photovoltaic module generated during this period of time can be detected and determined, respectively.

The power evaluation equipment is configured to compare the detected power parameter values, in particular, the aforementioned total powers. In particular, it is possible to determine which of the at least four compared power parameter values is the largest respectively represents the largest generated power.

From this, it can be deduced at which tracker angle the energy yield is currently greater and optimal, respectively. Based on the comparison result, the control device can adjust the tracker angle of the main solar tracker devices.

In particular, this can mean that the tracker angle of the main solar tracker devices is not adjusted if the currently set tracker angle of the main solar tracker device corresponds at least essentially to the tracker angle of the fixed reference solar tracker device that has generated the highest power parameter value.

In particular, the control device is configured to adjust the tracker angle of the main solar tracker devices if the comparison shows that the tracker angle with the highest power parameter value differs sufficiently (in particular, a minimum angle difference can be provided and defined, respectively) from the tracker angle of the main solar tracker devices. It shall be understood that in variants of the application, there must also be a minimum difference between the power parameter values so that an adjustment is actually carried out.

In particular, the comparison step can be formed by two comparison steps: In a first comparison step, the at least four performance parameter values are compared with each other and it is determined which of these at least four performance parameter values is the largest. Optionally and preferably additionally, in a second comparison step, the tracker angle of the reference solar tracker device with the determined largest power parameter value can be compared with the (currently) set tracker angle of the main solar tracker devices. If the difference between the set tracker angle of the main solar tracker devices and the tracker angle of the reference solar tracker devices with the determined largest power parameter value is at least greater than the (predetermined) minimum angle difference, the tracker angle of the reference solar tracker devices can be adjusted.

It shall be understood that the second comparison step can be omitted. In this case, the tracker angle of the main solar tracker devices can (always) be adjusted according to the angle of the reference solar tracker device with the determined highest power parameter value.

Preferably, the present photovoltaic system may comprise at least one optical detection equipment as described above. In particular, the present photovoltaic system may comprise a shading evaluation equipment as previously described. In other words, the two described photovoltaic systems (and preferred embodiments thereof) may be combined with each other.

A still further aspect of the application is a method of operating a photovoltaic system described above (in particular, according to claim 12 or 15), comprising:
comparing the electrical power parameter values generated by the photovoltaic reference system with each other, and
adjusting the tracker angle of the main solar tracker devices based on the comparison result.

It should be noted that a device, module, etc. may be formed of software components and/or hardware components. It should also be noted that expressions such as first, second, etc. do not indicate sequences but merely serve to distinguish between two elements, unless otherwise stated.

The features of the photovoltaic systems and methods can be freely combined with one another. In particular, features of the description and/or of the dependent claims can be inventive in their own right, even by completely or partially bypassing features of the independent claims, either on their own or freely combined with one another.

### BRIEF DESCRIPTION OF THE DRAWINGS

There are now a large number of possibilities for designing and further developing the photovoltaic systems and methods according to the application. For this purpose, reference is made on the one hand to the claims following the independent claims, and on the other hand to the description of embodiments in conjunction with the drawing. The drawing shows:

FIG. 1 shows a schematic view of an embodiment of a photovoltaic system according to the present application;

FIG. 2 shows a schematic view of a further embodiment of a photovoltaic system according to the present application;

FIG. 3a shows a schematic partial view of an embodiment of a photovoltaic system according to the present application in a first orientation state;

FIG. 3b shows a schematic partial view of the embodiment according to FIG. 3a in a second orientation state;

FIG. 4 shows a schematic partial view of a further embodiment of a photovoltaic system according to the present application;

FIG. 5 shows a schematic partial view of a further embodiment of a photovoltaic system according to the present application;

FIG. 6 shows a schematic partial view of a further embodiment of a photovoltaic system according to the present application;

FIG. 7 shows a diagram of an embodiment of a method according to the present application; and

FIG. 8 shows a diagram of a further embodiment of a method according to the present application.

### DETAILED DESCRIPTION OF THE INVENTION

In the following, similar reference signs are used for similar elements. It should also be noted that z denotes the vertical direction and x denotes a horizontal direction.

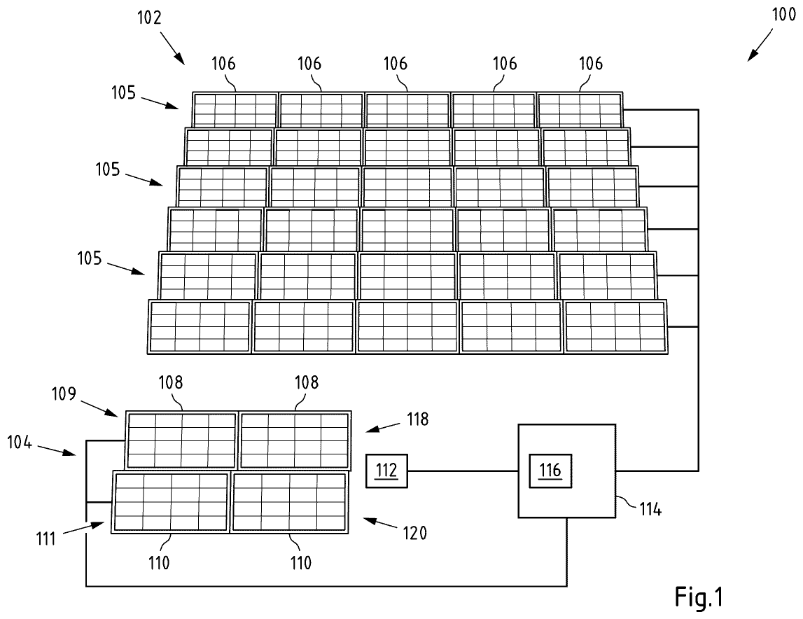

FIG. 1 shows a schematic view of an embodiment of a photovoltaic system 100 according to the present application, in particular, a photovoltaic system 100 installable on a substantially horizontal plane. For example, the photovoltaic system 100 may be arranged on a free ground. In particular, the photovoltaic system 100 is a tracking photovoltaic system 100.

The photovoltaic system 100 according to the application comprises a main photovoltaic system 102 and a photovoltaic reference system 104 corresponding to the main photovoltaic system 102. This means, in particular, that the photovoltaic reference system 104 is a scaled-down reproduction of the main photovoltaic system 102.

In the present embodiment, the main photovoltaic system 102 comprises a plurality of rows 105 (by way of example, six rows are shown) each comprising a plurality of main photovoltaic modules 106 (by way of example, five modules 106 are shown per row). The rows 105 run parallel to each other. In addition, all neighboring rows 105 have the same first distance to each other.

At least one horizontal single-axis main solar tracker device (explained in more detail below) is arranged in each row 105. A horizontal single-axis main solar tracker device comprises a support and at least one main photovoltaic module 106 arranged on the support, preferably, and as shown, a plurality of main photovoltaic modules 106 arranged directly adjacent to each other.

The photovoltaic reference system 104 shown in the present embodiment is a separate photovoltaic system 104 respectively external photovoltaic system 104. The photovoltaic reference system 104 may be arranged adjacent to, but at a distance from, the main photovoltaic system 102, as shown. As a result, in particular, the meteorological conditions and the installation ground of the photovoltaic reference system 104 and the main photovoltaic system 102 are (at least almost) identical.

In the present case, the photovoltaic reference system 104 has two rows 109, 111 running parallel to each other and, in particular, parallel to the rows 105 of the main photovoltaic system 102. A first row 109 comprises at least one horizontal single-axis reference solar tracker device with at least one first module element 108 (in the present case, two module elements 108 are shown by way of example). A second row 111 comprises at least one horizontal single-axis reference solar tracker device with at least one second module element 110 (in the present case, two module elements 110 are shown by way of example).

Here, at least the geometry, in particular, the outer contour, of the first module elements 108 and the geometry, in particular, the outer contour, of the second module elements 110 are identical to the geometry, in particular, the outer contour, of the main photovoltaic modules 106. In the present embodiment, in particular, the first and second module elements and the main photovoltaic modules 106, 108, 110 are identically formed photovoltaic modules 106, 108, 110.

In other variants of a separate photovoltaic reference system respectively external photovoltaic reference system according to the application, the use of functional photovoltaic modules can alternatively be at least partially dispensed with, as has already been described.

The first and second rows 109, 111 have a certain second distance to each other, which is identical to the first distance between the respective adjacent rows 105 of the main photovoltaic system 102.

In addition, the photovoltaic system 100 comprises at least one shading evaluation equipment 116 coupled to at least one optical detection equipment 112. In particular, the photovoltaic system 100 may also comprise the optical detection equipment 112. As an example, the shading evaluation equipment 116 is integrated in the control device 114 of the photovoltaic system 100.

As has been described, the shading evaluation equipment 116 is configured to determine a shading state of the first module element 108 and/or the second module element 108. This means, in particular, that it can be determined whether a first module element 108 causes a shadow on the second module element 110 or whether the second module element 110 causes a shadow on the first module element 108 or no shadow is caused on the module elements 108, 110.

The tracker angles of the reference solar tracker devices and the tracker angles of the main solar tracker devices are at least temporarily identical during the determination of the shading state of the first module element 108 and/or the second module element 110.

The control device 114 is configured to adjust the tracker angle of the main solar tracker devices (in particular, all main solar tracker devices have the same tracker angle) based on the determined shading state of the first module element 108 and/or the second module element 110. In particular, if it is determined that a shadow on the first respectively second module element 108, 110 is caused by the second respectively first module element 108, 110, the tracker angle of the main solar tracker devices is adjusted. If there is no shading, there is, in particular, no adjustment of the tracker angle of the main solar tracker devices.

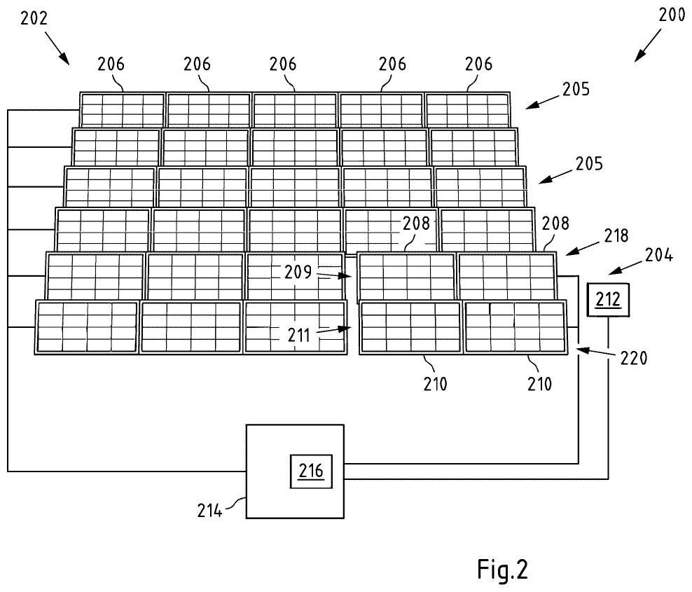

FIG. 2 shows a schematic view of a further embodiment of a photovoltaic system 200 according to the present application. In particular, in order to avoid repetitions, essentially only the differences to the embodiment according to FIG. 1 are described below. With regard to the other components of the photovoltaic system 200, reference is made, in particular, to the explanations relating to FIG. 1.

In comparison to the previous embodiment, the photovoltaic reference system 204 in the present case is an internal subsystem 204 of the main photovoltaic system 202. In other words, the main photovoltaic system 202 comprises the photovoltaic reference system 204 (this is schematically indicated in FIG. 2 by a small distance between the photovoltaic reference system 204 and the other modules). The photovoltaic reference system 204 is thus a part of the main photovoltaic system 202. In this embodiment, the first and second module elements 208, 210 are designed as main photovoltaic modules, which take the function of reference photovoltaic modules.

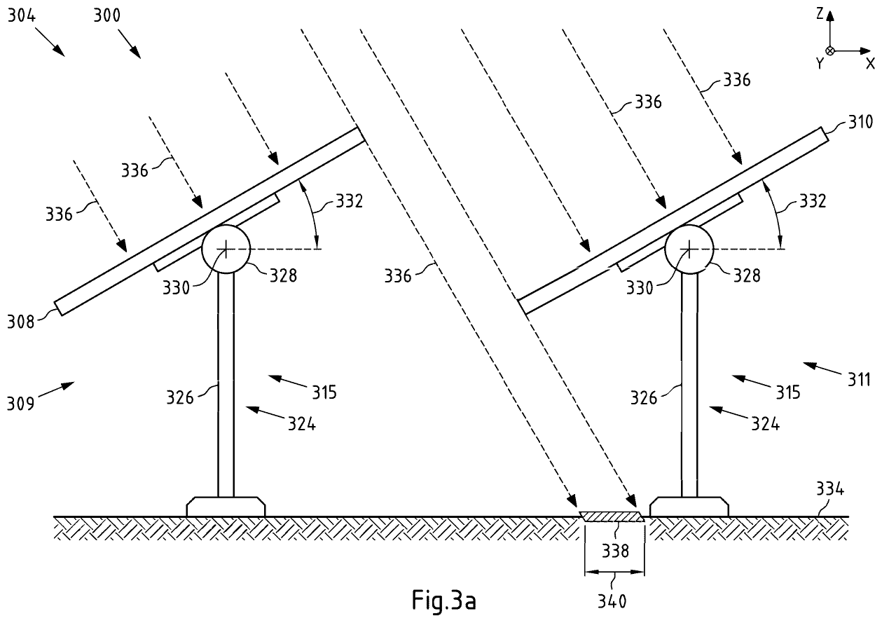

FIGS. 3a and 3b show schematic partial views of an embodiment of a photovoltaic system 300. In particular, a schematic sectional view of a photovoltaic reference system 304 is shown. The photovoltaic reference system 304 can be formed, for example, according to FIG. 1 or 2.

First, a solar tracker device 315, in the present case a reference solar tracker device 315, is shown in more detail in FIGS. 3a and 3b. It should be noted that a main solar tracker device can be formed identically. The only difference may be that a main solar tracker device may carry more photovoltaic modules, in particular, may have a greater extension in the longitudinal direction respectively axial direction of the elongate support element 328.

A horizontal single-axis solar tracker device 315 comprises a support 324 and at least one photovoltaic module 308, 310 (respectively module element 308, 310) arranged on the support 324, preferably a plurality of photovoltaic modules 308, 310 arranged directly adjacent to each other.

The support may be formed by at least one support base 326 and at least one elongate support element 328 attached to the support base 326. For example, a support base 326 may be arranged at each of the outer ends of the elongate support element 328 (e.g., a rod 328, for example, made of metal).

In the illustrated installation state of a solar tracker device 315, the elongate support element 328 is arranged in a substantially horizontally extending plane (in particular, substantially parallel to a plane on which the at least one support base 326 is placed).

In the present single-axis horizontal solar tracker devices 315 respectively solar trackers 315, the elongate support element 328 is preferably formed by a cylindrical support element 328, for example, a horizontal tube. Such an elongate support element 328 can comprise pylons or frames as support base/s 326, on which the elongate support element 328 can be mounted.

In the installation state, the axis 330 of the elongate support element 328 can, for example, lie on a north-south line.

The at least one reference photovoltaic module 308, 310 may be mounted on the elongate support element 328. The elongate support element 328 may be rotatable about its axis 330 in order to adjust the tracker angle 332 of the solar tracker device 315. In particular, this allows tracking of the apparent movement of the sun throughout the day.

In order to rotate the elongate support element 328, each solar tracker device 315 can preferably comprise a controllable drive (not shown), for example, in the form of an electric motor. In particular, the drive can be controlled by the control device of the photovoltaic system 300 (not shown in this embodiment) in order to cause an adjusting of the tracker angle 332 of a solar tracker device 315.

A parallel arrangement of two solar tracker devices 315 to each other means, in particular, that the respective elongated support elements 328 respectively their axes 330 run essentially parallel to each other.

Furthermore, reference signs 336 denote incident light beams, reference sign 332 denotes the set tracker angle (in the present case the angle between a horizontal plane and the photovoltaic module) and reference sign 334 denotes the installation surface.

In the present case, the photovoltaic system 300 comprises an optical detection equipment in the form of at least one camera. For the sake of a better overview, a camera is not shown here. In particular, the camera is configured to detect a light area 338 occurring on the installation surface 334 between the first row 309 and the second row 311 of the photovoltaic reference system 311.

In particular, the presence or absence of a light area 338, which is formed by light beams 336 impinging on the installation surface 334 between the rows 309, 311, can be used to infer the shading state of the first and/or second module element 308, 310. As long as a light area 338 can be detected on the installation surface 334, it can be concluded from this that there is no shading, i.e., the shading state is “no shading”.

If there is no light area, it can be concluded that the shading state is “shading occurred”. Preferably, it is also possible to check whether electrical energy (above a certain limiting energy) is being generated by main photovoltaic modules and/or reference photovoltaic modules.

For example, FIG. 3a shows the case in which the set tracker angle 332 or the current orientation state of the reference solar tracker devices 315 does not lead to any mutual shading, since a light area 338 is detected on the installation surface 334. The shading state is therefore “no shading”. It is not necessary to adjust the tracker angle of the main solar tracker devices, which, in particular, is identical to the tracker angle 332.

FIG. 3b, on the other hand, shows the case in which the set tracker angle 332 respectively the current orientation state of the reference solar tracker devices 315 leads to shading in the area 341 on the module element 310. As can be seen, in this case no light area is present on the installation surface 334 and therefore cannot be detected. From this, the shading evaluation equipment can deduce that shading is present or at least in the process of being created. The shading state is therefore in particular “shading occurred”.

In this case, the tracker angle of the main solar tracker devices can be adjusted. As described, the adjustment can be carried out according to at least one predetermined rule.

The tracker angle 332 can be adjusted accordingly. After an adjustment of the tracker angle 332 (or already during the adjustment), the at least one camera and the shading evaluation equipment can again determine whether a light area is present or not. If necessary, a further adjustment of the tracker angle of the main solar tracker devices may be required.

Preferably, the shading evaluation equipment can be configured to determine the width 340 of the detected light area 338. For example, the shading evaluation equipment can be configured to compare the width 340 of the detected light area 338 with a light area width criterion. Based on this comparison result, the shading state can be determined.

If a light area width criterion (e.g., certain permissible minimum light area width) is fulfilled by the width 340 of the detected light area 338 (e.g., the detected width 340 of the light area 338 is greater than the permissible minimum light area width), it can be concluded, for example, that the shading state is “no shading”. If the light area width criterion is not fulfilled by the width 340 of the detected light area 338 (e.g., the detected width 340 of the light area 338 is smaller than the permissible minimum light area width; in particular, this also includes the case where the detected width is 0 or no light area can be detected), the shading state “shading has occurred” and/or “shading is occurring” can be inferred, for example.

Preferably, the width can be evaluated as a function of time, i.e., the change in width over time can be evaluated. If the width decreases, “shading is occurring” can also be detected. Preferably, the photovoltaic system can be operated and, in particular, the tracker angle of the main solar tracker devices can be adjusted in such a way that the width is always kept within a certain width range.

For evaluation, the shading evaluation equipment can, in particular, use an image evaluation tool to determine the brightness in the detected optical data, in particular, image data.

Alternatively or in addition to the at least one camera, at least one light sensor (not shown here) arranged between the first row 309 and the second row 311 of the photovoltaic reference system 304 may also be provided on the installation surface 334. An example of such a sensor is a Heliatek film.

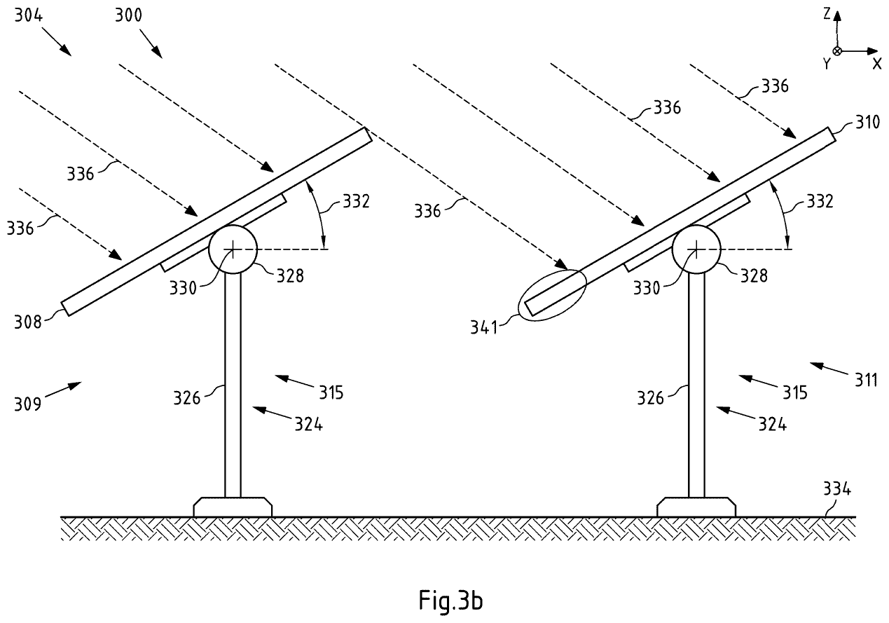

FIG. 4 shows a schematic partial view of an embodiment of a photovoltaic system 400. In particular, a schematic top view of a photovoltaic reference system 404 is shown. The photovoltaic reference system 404 can be formed, for example, according to FIG. 1 or 2. In order to avoid repetitions, essentially only the differences to the previous embodiments (in particular to FIGS. 3a and 3b) are described below and reference is otherwise made to the previous embodiments.

In the present embodiment, a light sensor 454, 456 is provided on each of the opposing edges 450 of the first and second module elements 408, 410 (by way of example photovoltaic modules). For example, a light sensor 454, 456 may comprise respectively be formed by at least one photodiode, preferably a plurality of photodiodes. Depending on the incident light intensity, the first light sensor 454 of the first module element 408 and/or the second light sensor 456 of the second module element 410 can generate a sensor signal and, in particular, make it available to the shading evaluation equipment 416, as described above. In this way, it can be easily determined whether shading has occurred or not.

As can be seen, the edge 450 of the first module element 408, on which the first light sensor 454 is arranged, and the edge 450 of the second module element 410, on which the second light sensor 456 is arranged, are in an installation state and in particular in the respective horizontal position (as shown) of the module elements 408, 410, facing each other respectively arranged opposite each other. The respective light sensor 454, 456 extends, in particular, at least partially along the edge 450, preferably almost completely.

Preferably, the shading evaluation equipment 416 can be configured to determine the shading state of the first module element 408 and/or the second module element 410 based on a light state of the first light sensor 454 and/or a light state of the second light sensor 456, i.e., in particular, on the sensor signals received.

As can be seen from FIG. 4, the first and/or second light sensor 454, 456 can preferably have at least two adjacent rows of light sensors 458, 460, which, in particular, run parallel to the installation surface. Depending on whether light (with at least one certain minimum intensity) falls on respectively is detected on both light sensor rows 458, 460, only on one light sensor row 458, 460 or on no light sensor row 458, 460, the shading state can be determined in a simple manner.

In particular, the shading evaluation equipment 416 can be configured to determine, as the shading state, “no shading” in the event that solar radiation (with at least one certain minimum intensity) falls on both light sensor rows, “shading is occurring” in the event that light falls on only one light sensor row 458, 460 (in particular, the bottom row as seen in the vertical direction) is exposed to solar radiation (with at least one certain minimum intensity) and a “shading occurred” in the event that none of the light sensor rows 458, 460 is exposed to solar radiation (with at least one certain minimum intensity) based on the light state of the first light sensor row 458 and the light state of the second light sensor row 460.

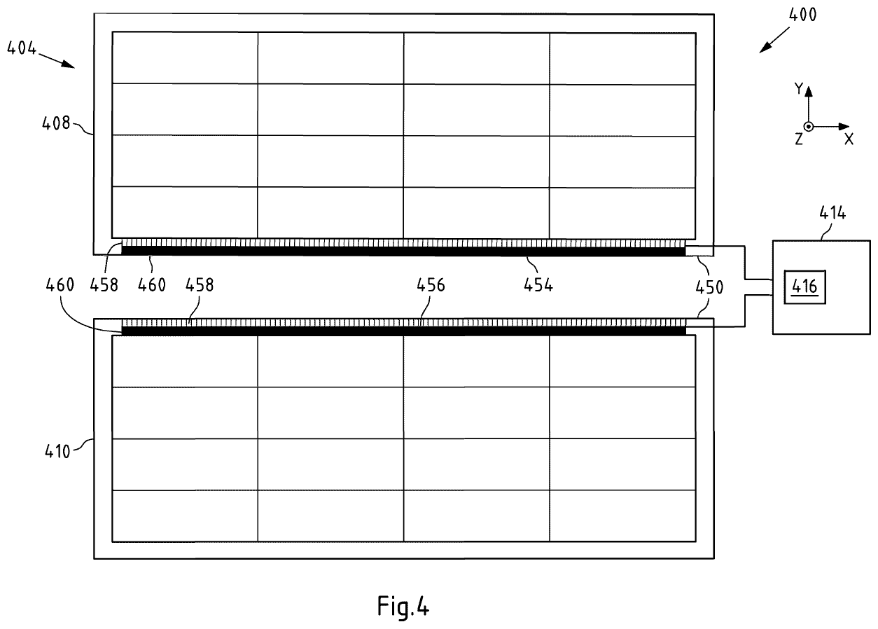

FIG. 5 shows a schematic partial view of an embodiment of a photovoltaic system 500. In particular, a schematic top view of a photovoltaic reference system 504 is shown. The photovoltaic reference system 504 can be formed, for example, according to FIG. 1 or 2. In particular, it can be an internal or external photovoltaic reference system 504. In order to avoid repetitions, essentially only the differences to the previous embodiments (in particular, to FIGS. 3a and 3b) are described below and reference is otherwise made to the previous embodiments.

As can be seen, the photovoltaic reference system 504 herein comprises a first row 509 with at least one horizontal single-axis reference solar tracker device 515 having at least one first reference photovoltaic module 508 and at least one second row 511 with at least one horizontal single-axis reference solar tracker device 515 having at least one second reference photovoltaic module 510. The first reference photovoltaic module 508 and the second reference photovoltaic module 510 are identical to the main photovoltaic modules of the main photovoltaic system.

The photovoltaic system 500, in particular the photovoltaic reference system 504, comprises a power evaluation equipment 560. As an example, this is integrated in the control device 514 in the present case. The power evaluation equipment 560 is configured to compare a first electrical power parameter value generated by the first reference photovoltaic module 508 and a second electrical power parameter value generated by the second reference photovoltaic module 510.

As can be seen from FIG. 5, the set tracker angles 532.1, 532.2 of the first reference photovoltaic module 508 and the second reference photovoltaic module 510 are different, at least during the detecting of the respective power parameter value. Preferably, the tracker angle 532.1 of the horizontal single-axis reference solar tracker device 515 of the first reference photovoltaic module 508 is identical to the set tracker angle of the main solar tracker devices. Further, the tracker angle 532.2 of the horizontal single-axis reference solar tracker device 515 of the second reference photovoltaic module 510 differs from the set tracker angle of the main solar tracker devices (and thus also from the tracker angle 532.1). In particular, the tracker angle 532.2 can be adjusted independently of the other tracker angles (indicated by the reference sign 562).

As has been explained, the power evaluation equipment 560 is configured to carry out a comparison operation. In particular, the power evaluation equipment 560 can determine which of the at least two compared power parameter values is greater. From this, it can be derived at which tracker angle 532.1, 532.2 the energy yield is currently greater.

Based on the comparison result, the control device 514 can adjust the tracker angle of the main solar tracker devices. In particular, this means that the tracker angle of the main solar tracker devices is not adjusted if the first power parameter value is greater than or equal to the second power parameter value.

In particular, the control device 514 is configured to adjust the tracker angle of the main solar tracker devices if the second power parameter value is greater than the first power parameter value. It shall be understood that in variants of the application, there must be a minimum difference between the power parameter values so that an adjustment is actually carried out.

Preferably, the control device 514 may be configured to adjust the tracker angle 532.2 of the horizontal single axis reference solar tracker device 515 of the second reference photovoltaic module 510 starting from the tracker angle 532.1 of the horizontal single axis reference solar tracker device 515 of the first reference photovoltaic module 508 (respectively the main tracker devices) by a first (preferably positive) angular value during a first period of time. The control device may further be configured to adjust the tracker angle 532.2 of the horizontal single-axis reference solar tracker device 515 of the second reference photovoltaic module 510 by a second (preferably negative) angular value during a second period of time (subsequent to the first period of time), starting from the tracker angle 532.1 of the horizontal single-axis reference solar tracker device 515 of the first reference photovoltaic module 508. The first and second angular values differ here. It shall be understood that further angular adjustments may be made.

The power evaluation equipment 560 may be configured to compare a second power parameter value generated during the first time duration, a further power parameter value generated during the second time duration and the first power parameter value generated during the first respectively second time duration.

The control device 514 may be configured to adjust the tracker angle of the main solar tracker devices based on the comparison result. In particular, if it is determined that the generated first power parameter value is the largest, no adjustment is made. If it is determined that the second power parameter value generated during the first time period is the largest, an adjustment of the tracker angle of the main solar tracker devices may be performed according to the tracker angle 532.2 set during the first time period. If it is determined that the second power parameter value generated during the second time period is the largest, an adjustment of the tracker angle of the main solar tracker devices may be made according to the tracker angle 532.2 set during the second time period.

In particular, this operation may be performed regularly and/or at specific times and/or under specific meteorological conditions to determine the optimal orientation of the main solar tracker devices.

Optionally, as shown, for example, in FIG. 3 and/or FIG. 4, at least one optical detection equipment and at least one shading evaluation equipment may additionally be provided.

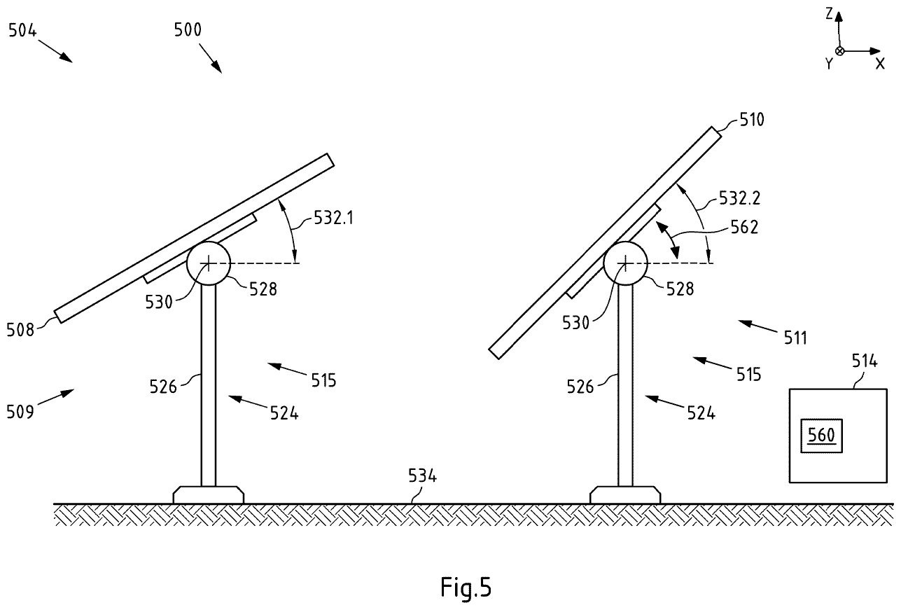

FIG. 6 shows a schematic partial view of an embodiment of a photovoltaic system 600. In particular, a schematic sectional view or side view of a photovoltaic reference system 604 is shown. The photovoltaic reference system 504 can be formed, for example, according to FIG. 1 or 2. In particular, it may be an internal or external photovoltaic reference system 604. In order to avoid repetitions, essentially only the differences to the previous embodiments (in particular to FIGS. 3a and 3b) are described below and reference is otherwise made to the previous embodiments.

In particular, the embodiment of FIG. 6 differs from FIG. 5 in that at least four fixed horizontal single-axis reference solar tracker devices 670, 672, 674, 676 are provided in the present case, each having (exactly) one reference photovoltaic module 608, 610, 617, 619. As can be seen, the four fixed horizontal single-axis reference solar tracker devices 670, 672, 674, 676 have different and invariable tracker angles 623.1, 632.2, 632.3, 632.4.

In addition, similar to FIG. 5, at least one power evaluation equipment 660 is provided. As an example, this is integrated in the control device 614.

The power evaluation equipment 660 is at least configured to compare the electrical power parameter values generated by the four fixed horizontal single-axis reference solar tracker devices 670, 672, 674, 676. In particular, this comparison can be used to determine which generated power parameter value is the highest value and thus which tracker angle 623.1, 632.2, 632.3, 632.4 of the at least four tracker angles 623.1, 632.2, 632.3, 632.4 is the currently optimum tracker angle.

Based on this comparison result, the tracker angle of the main solar tracker devices is adjusted by the control device 614.

In particular, the power evaluation equipment 660 can perform two comparison steps. In a first comparison step, the at least four power parameter values are compared with each other and it is determined which of these at least four power parameter values is the largest, as already described.

In a second comparison step, the tracker angle 623.1, 632.2, 632.3, 632.4 of the reference solar tracker device 670, 672, 674, 676 with the determined largest power parameter value is compared with the (currently) set tracker angle of the main solar tracker devices. If the difference between the set tracker angle of the main solar tracker devices and the tracker angle 623.1, 632.2, 632.3, 632.4 of the reference solar tracker device 670, 672, 674, 676 with the determined largest power parameter value is at least greater than a (predefined) minimum angle difference, the tracker angle of the main solar tracker devices is adjusted by the control device 614. Otherwise, adjustment can be omitted.

Optionally, as shown for example in FIG. 3 and/or FIG. 4, at least one optical detection equipment and at least one shading evaluation equipment can also be provided.

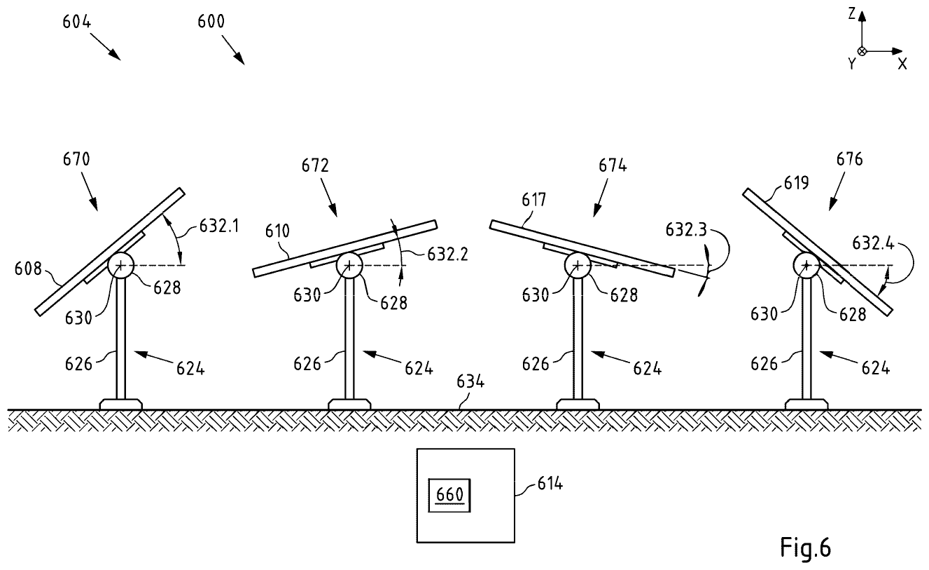

FIG. 7 shows a diagram of an embodiment of a method according to the present application. The illustrated method is used, in particular, for operating a photovoltaic system according to the embodiment shown in FIGS. 3a, 3b and/or 4.

In a step 701, a determining of a shading state of the first module element and/or the second module element is performed, in particular, by a shading evaluation equipment (as already described).

In a further step 702, an adjusting of the tracker angles of the main solar tracker devices is performed, in particular, by a control device, based on the determined shading state of the first module element and/or the second module element (as already described).

The steps 701 and 702 can preferably be performed at least almost continuously (for example, at regular (short) predetermined time intervals).

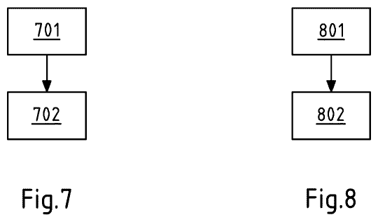

FIG. 8 shows a diagram of a further embodiment of a method according to the present application. The illustrated method is used, in particular, for operating a photovoltaic system according to the embodiment according to FIG. 5 or 6.

In a step 801, a comparing of the electrical power parameter values generated by the photovoltaic reference system with each other is performed, in particular, by a power evaluation equipment (as already described).

In a step 802, an adjusting of the tracker angle of the main solar tracker devices is performed, in particular, by a control device, based on the comparison result (as already described).

The steps 801 and 802 can preferably be carried out regularly (for example at predetermined time intervals).

The methods according to FIGS. 7 and 8 can particularly preferably be combined with each other. In particular, the steps 701, 801, 702, 802 can then be carried out at least partially in parallel. The performance yield can be further increased.

The aspects of the application described above consist in particular of creating a small “test setup” or photovoltaic reference system next to the actual system or main photovoltaic system in order to estimate and check an optimized alignment of the tracker (or solar tracker device) of the main photovoltaic system.

Thus, the photovoltaic reference system may comprise two groups (P1G1, P1G2) or a first row and a second row (as described) of solar panels, each group or row having the same number of modules and each group being mounted on a short tracker and placed at the same distance from each other as the actual installation. In particular, the orientation of the two trackers is identical to that of the main photovoltaic system.

In particular, each row of modules is connected to its own inverter or micro-inverter (respectively inverter). In this way, the structure of the photovoltaic reference system “mirrors” the current structure of the main photovoltaic system and serves as a reference. If, for example, the modules in the main photovoltaic system were to cast shadows on each other, the same would happen to the modules in the photovoltaic reference system.

Optionally, the alignment of the tracker can be varied quickly and is used to optimize the alignment.

Furthermore, at least one camera can be provided to monitor the ground between the two trackers of the respective part.

As described, each day all trackers can be aligned horizontally to the ground by the photovoltaic reference system and/or the main photovoltaic system. The output power of each row is measured, i.e., for example P(P1G1), P(P1G2) P(P2G1), P(P2G2). These are used as calibration. Any differences observed are due to differences in the performance of the modules and the inverter itself, not due to the different orientation of the trackers.

The modules can cast shadows on the ground. As long as no shadow is cast from one module to the next, there is an area on the ground that is not shaded. As long as the camera can see this bright area, there is no shading problem. However, this bright area shrinks as the modules approach the point where they shade each other. For example, when the width of the light area on the ground drops below a certain minimum W(min), the photovoltaic reference system will increase tracking, i.e., move the modules (of the photovoltaic reference system and the main photovoltaic system) to a position that is more in the “horizontal” direction. If the modules of the second row have a power above the threshold, the trackers of the main photovoltaic system can receive the signal to adjust the angle of the trackers to the angle of the trackers of the second row.

At a certain (predetermined) frequency, the photovoltaic reference system can change the angle of a tracker up and/or down by a certain angle. In these two positions, it measures the respective powers as described. If, for a certain period of time, the power of the second row is higher than the power of the first row by at least one predetermined minimum, then the trackers of the main photovoltaic system can receive a signal to adjust its tracker angle to the angle of the second row.

Optionally, additional sensors can be provided. For example, an installation of two pyranometers can be provided, one for GHI and one for DNI. If the ratio of the irradiance of DNI divided by the irradiance of GHI for a given period of time meets a certain ratio criterion, then the photovoltaic reference system can move one row to a horizontal position. If the power of this second row is greater than that of the other row by a certain minimum value for a certain minimum time, then the trackers of the main photovoltaic system may receive a signal to adjust the angle of the trackers to the angle of said second row.

Alternatively or additionally, during the day, the photovoltaic reference system can move one row to a horizontal position at predefined times (e.g. every 15 minutes). When the power of this second row is greater than the power of the other row by a defined minimum value for a defined minimum time, the trackers of the main photovoltaic system may receive a signal to adjust the angle of the trackers to the angle of said second row.

As already described, devices such as photodiodes can be used on the outer edges of the modules instead of one or more cameras. These can be mounted at two distances and in particular give signals “shading is imminent” and “shading is taking place”. This enables the evaluation and/or control device in particular to keep the module in the “shading is imminent” position using suitable tracking algorithms. Depending on the location, the photodiodes can be placed at the points that are most susceptible to shading (if the surface is not completely flat or the rows are not completely parallel).

If the photodiodes cannot be protected, one alternative in particular is to place a thin strip of a long PV cell under the rows parallel to the ground, e.g., a Heliatek foil. In the event of a short circuit, the current generated by this cell would drop significantly when the shading situation is reached, as direct sunlight no longer hits the cell, which can be used as an input signal for tracing.

In order to determine the best angle in hazy or similar meteorological conditions, several small permanently installed PV cells with a fixed tilt but different tilt angles or tracker angles can be used as described and operated in short-circuit mode. This can be used to learn whether there is a better position than the one facing the sun.

Furthermore, a photovoltaic reference system can be used to determine when to switch from back-tracking mode to normal tracking mode and vice versa.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A photovoltaic system installable on a substantially planar installation surface, comprising:
at least one main photovoltaic system having:
a plurality of horizontal single-axis main solar tracker devices arranged in parallel rows, each having at least one main photovoltaic module,
wherein two horizontal single-axis main solar tracker devices arranged in adjacent rows have a first distance to each other,
at least one control device configured to adjust a tracker angle of the main solar tracker devices,
wherein the photovoltaic system further comprises
at least one photovoltaic reference system corresponding to the main photovoltaic system and having:
a first row with at least one horizontal single-axis reference solar tracker device having at least one first module element,
at least one second row with at least one horizontal single-axis reference solar tracker device having at least one second module element, wherein at least the geometry of the first module element and the geometry of the second module element are identical to the geometry of the main photovoltaic module,
wherein the first row and the second row are arranged parallel to each other and have a second distance to each other which is identical to the first distance,
at least one shading evaluation equipment coupled to at least one optical detection equipment and configured to determine a shading state of the first module element and/or of the second module element,
wherein the tracker angles of the reference solar tracker devices and the tracker angle of the main solar tracker devices are at least temporarily identical during the determination of the shading state of the first module element and/or the second module element,
wherein the control device is configured to adjust the tracker angle of the main solar tracker devices based on the determined shading state of the first module element and/or the second module element.

2. The photovoltaic system according to claim 1, wherein
the photovoltaic reference system is a subsystem of the main photovoltaic system, and
the control device is configured to adjust a tracker angle of the reference solar tracker devices.

3. The photovoltaic system according to claim 1, wherein
the photovoltaic reference system is a separate photovoltaic system, and
the control device is configured to adjust a tracker angle of the reference solar tracker devices.

4. The photovoltaic system according to claim 1, wherein
the photovoltaic system comprises the at least one optical detection equipment,
wherein the optical detection equipment is a camera configured to detect a light area occurring on the installation surface between the first row and the second row of the photovoltaic reference system.

5. The photovoltaic system according to claim 4, wherein
the shading evaluation equipment is configured to determine the width of the detected light area,
wherein the shading evaluation equipment is configured to compare the width of the detected light area with a light area width criterion, and
wherein the shading evaluation equipment is configured to determine the shading state of the first module element and/or the second module element based on the comparison result.

6. The photovoltaic system according to claim 1, wherein
the photovoltaic system comprises the at least one optical detection equipment,
wherein the optical detection equipment comprises at least one first light sensor arranged at an edge of the first module element and at least one light sensor arranged at an edge of the second module element.

7. The photovoltaic system according to claim 1, wherein
the shading evaluation equipment is configured to determine the shading state of the first module element and/or the second module element based on a light state of the first light sensor and/or a light state of the second light sensor.

8. The photovoltaic system according to claim 1, wherein
the photovoltaic system comprises the at least one optical detection equipment,
wherein the optical detection equipment is an elongated light sensor arranged on the installation surface between the first row and the second row of the photovoltaic reference system.

9. The photovoltaic system according to claim 1, wherein
the shading evaluation equipment is configured to determine the shading state of the first module element and/or of the second module element based on a light state of the elongate light sensor arranged on the installation surface.

10. The photovoltaic system according to claim 1, wherein
the first module element is a first reference photovoltaic module and the second module element is a second reference photovoltaic module, wherein the first reference photovoltaic module and the second reference photovoltaic module are identical to the main photovoltaic module,
wherein the photovoltaic reference system comprises at least one power evaluation equipment configured to compare a first electrical power parameter value generated by the first reference photovoltaic module and a second electrical power parameter value generated by the second reference photovoltaic module,
wherein the tracker angle of the horizontal single-axis reference solar tracker device of the first reference photovoltaic module is identical to the set tracker angle of the main solar tracker devices and the tracker angle of the horizontal single-axis reference solar tracker device of the second reference photovoltaic module is different from the set tracker angle of the main solar tracker devices,
wherein the control device is configured to adjust the tracker angle of at least one of the main solar tracker devices based on the comparison result.

11. A method for operating a photovoltaic system according to claim 1, comprising:
determining a shading state of the first module element and/or the second module element, and
adjusting the tracker angle of the main solar tracker devices based on the determined shading state of the first module element and/or the second module element.

12. A photovoltaic system installable on a substantially flat installation surface, comprising:
at least one main photovoltaic system having:
a plurality of horizontal single-axis main solar tracker devices arranged in parallel rows, each having at least one main photovoltaic module,
wherein two horizontal single-axis main solar tracker devices arranged in adjacent rows have a first distance to each other,
at least one control device configured to adjust a tracker angle of the main solar tracker devices,
wherein the photovoltaic system further comprises
at least one photovoltaic reference system corresponding to the main photovoltaic system, having:
a first row with at least one horizontal single axis reference solar tracker device having at least one first reference photovoltaic module,
at least one second row with at least one horizontal single-axis reference solar tracker device having at least one second reference photovoltaic module, wherein the first reference photovoltaic module and the second reference photovoltaic module are identical to the main photovoltaic module,
at least one power evaluation equipment configured to compare a first electrical power parameter value generated by the first reference photovoltaic module and a second electrical power parameter value generated by the second reference photovoltaic module,
wherein the tracker angle of the horizontal single-axis reference solar tracker device of the first reference photovoltaic module is identical to the set tracker angle of the main solar tracker devices and the tracker angle of the horizontal single-axis reference solar tracker device of the second reference photovoltaic module is different from the set tracker angle of the main solar tracker devices,
wherein the control device is configured to adjust the tracker angle of the main solar tracker devices based on the comparison result,
wherein the control device is configured to adjust the tracker angle of the horizontal single-axis reference solar tracker device of the second reference photovoltaic module starting from the tracker angle of the horizontal single-axis reference solar tracker device of the first reference photovoltaic module by a first angular value during a first time period, and
wherein the control device is configured to adjust the tracker angle of the horizontal single-axis reference solar tracker device of the second reference photovoltaic module starting from the tracker angle of the horizontal single-axis reference solar tracker device of the first reference photovoltaic module by a second angular value during a second time period,
wherein the power evaluation equipment is configured to compare a second power parameter value generated during the first time period, a further power parameter value generated during the second time period and the generated first power parameter value, and
wherein the control device is configured to adjust the tracker angle of the main solar tracker devices based on the comparison result.

13. A photovoltaic system installable on a substantially flat installation surface, comprising:
at least one main photovoltaic system having:
a plurality of horizontal single-axis main solar tracker devices arranged in parallel rows, each having at least one main photovoltaic module,
wherein two horizontal single-axis main solar tracker devices arranged in adjacent rows have a first distance to each other,
at least one control device configured to adjust a tracker angle of the main solar tracker devices,
wherein the photovoltaic system further comprises
at least one photovoltaic reference system corresponding to the main photovoltaic system, having:
a first row with at least one horizontal single axis reference solar tracker device having at least one first reference photovoltaic module,
at least one second row with at least one horizontal single-axis reference solar tracker device having at least one second reference photovoltaic module, wherein the first reference photovoltaic module and the second reference photovoltaic module are identical to the main photovoltaic module,
at least one power evaluation equipment configured to compare a first electrical power parameter value generated by the first reference photovoltaic module and a second electrical power parameter value generated by the second reference photovoltaic module,
wherein the tracker angle of the horizontal single-axis reference solar tracker device of the first reference photovoltaic module is identical to the set tracker angle of the main solar tracker devices and the tracker angle of the horizontal single-axis reference solar tracker device of the second reference photovoltaic module is different from the set tracker angle of the main solar tracker devices,
wherein the control device is configured to adjust the tracker angle of the main solar tracker devices based on the comparison result,
wherein the control device is configured to adjust the horizontal single-axis reference solar tracker device of the first reference photovoltaic module and the second reference photovoltaic module each to a horizontal position during a calibration period,
wherein the power evaluation equipment comprises a calibration module configured to calibrate the power evaluation equipment based on the first electrical power parameter value generated during the calibration time period and the second electrical power parameter value generated during the calibration time period.

14. A photovoltaic system installable on a substantially planar installation surface, comprising:
at least one main photovoltaic system having:
a plurality of horizontal single-axis main solar tracker devices arranged in parallel rows, each having at least one main photovoltaic module,
wherein two horizontal single-axis main solar tracker devices arranged in adjacent rows have a first distance to each other,
at least one control device configured to adjust a tracker angle of the main solar tracker devices,
wherein the photovoltaic system further comprises
at least one photovoltaic reference system having:
at least four fixed horizontal single-axis reference solar tracker devices each having a reference photovoltaic module, wherein the orientation of the reference photovoltaic module of a respective reference solar tracker device is not variable,
wherein the four fixed horizontal single-axis reference solar tracker devices have different tracker angles,
at least one power evaluation equipment configured to compare the electrical power parameter values generated by the four fixed horizontal single-axis reference solar tracker devices,
wherein the control device is configured to adjust the tracker angle of the main solar tracker devices based on the comparison result.

15. A method of operating a photovoltaic system according to claim 12, comprising:
comparing the electrical power parameter values generated by the photovoltaic reference system with each other, and
adjusting the tracker angle of the main solar tracker devices based on the comparison result.

16. The photovoltaic system according to claim 2, wherein
the control device is configured to adjust the tracker angle of the reference solar tracker devices independently of the set tracker angle of the main solar tracker devices of the main photovoltaic system.

17. The photovoltaic system according to claim 3, wherein
the control device is configured to adjust the tracker angle of the reference solar tracker devices independently of the set tracker angle of the main solar tracker devices of the main photovoltaic system.
